(19) United States
(12) Patent Application Publication
(10) Pub. No.: US 2010/0197261 A1
(43) Pub. Date: Aug. 5, 2010

(54) WIRELESS CONTROL SUBSYSTEM FOR A MOBILE ELECTRONIC DEVICE

(75) Inventors: Larry J. Zibrik, Surrey (CA); Trent Punnett, Vancouver (CA); W. Ross Gray, Vancouver (CA); Peter McConnell, Vancouver (CA)

Correspondence Address: Nixon Peabody LLP, P.O. Box 60610, Palo Alto, CA, 94306, US

(73) Assignee: SIERRA WIRELESS, INC., Richmond (CA)

(21) Appl. No.: 12/692,570

(22) Filed: Jan. 22, 2010

Related U.S. Application Data
(60) Provisional application No. 61/147,540, filed on Jan. 27, 2009.

(51) Int. Cl. H04B 1/06

(52) U.S. Cl. 455/232.1; 455/230

(57) ABSTRACT

Methods and apparatus are provided for wireless communications in a mobile electronic device. In one aspect, the mobile electronic device includes an antenna subsystem and a plurality of wireless communications modules. A method may involve supplying RF signals from each of the wireless communications modules to a single unit for manipulating the RF signals; and controlling the unit for manipulating RF signals to connect an RF signal of a selected one of the wireless communications modules to the antenna subsystem. The unit for manipulating RF signals may perform various kinds of RF signal processing or conditioning. Furthermore, the antenna system may include a phased array antenna. Besides portable computers such as laptop, notebook and netbook computers, the same principles are applicable to mobile electronic devices generally, including cellphones for example.

### CROSS-REFERENCE TO RELATED APPLICATIONS

This application claims priority to U.S. Provisional Application Ser. No. 61/147,540 filed Jan. 27, 2009.

### FIELD OF THE INVENTION

The present invention relates to wireless communications systems. More specifically, the present invention relates to wireless communications systems for portable computers and mobile electronic devices.

### BACKGROUND

When integrating a single wireless communications module into a platform such as a laptop, cellphone, etc., the manufacturer generally lacks many of the skills required to successfully mate their computing platform with the wireless technologies. Issues arise such as proper placement of the antenna inside the laptop, grounding and ground plane performance for the antenna(s), requirements to provide multiple antennas for diversity schemes such as transmit diversity, MIMO, etc., the large number of antennas required in case of multiple wireless standards (i.e. Bluetooth, WiFi, ZigBee), physical space requirements, electromagnetic interference from the platform which degrades the performance of the wireless devices, optimal use of limited space for the antennas, etc.

### Overview

Methods and apparatus are provided for wireless communications in a mobile electronic device. In one aspect, the mobile electronic device includes an antenna subsystem and a plurality of wireless communications modules. A method may involve supplying RF signals from each of the wireless communications modules to a single unit for manipulating the RF signals; and controlling the unit for manipulating RF signals to connect an RF signal of a selected one of the wireless communications modules to the antenna subsystem. The unit for manipulating RF signals may perform various kinds of RF signal processing or conditioning. Furthermore, the antenna system may include a phased array antenna. Although the following discussion will refer primarily to portable computers such as laptop, notebook and netbook computers, the same principles are applicable to mobile electronic devices generally, including cellphones for example.

The present methods and apparatus, in various aspects thereof, allow for: 1. Improved Transmit and Receive performance for all wireless technologies built into laptop computers and small form factor computing devices using a single antenna subsystem. 2. Isolation and control of path loss and phase loss between primary wireless engines and their respective antenna systems. 3. Improved reuse and control of antenna systems within the platform. 4. Improved control of multiple wireless technologies in one subsystem. 5. A better reference design framework for PC Original Equipment Manufacturers (OEMs) to implement multiple wireless technologies with faster time to market and lower engineering development risk. 6. Simplification of the antenna subsystem platform installation/integration into the laptop or small form factor device by providing a flexible fully integrated antenna subsystem, minimizing the effort and expertise required by the platform manufacturer.

One apparatus may take the form of a 3G module that resides in the display area of a laptop, thereby having closer proximity to the antenna system, and that buffers and controls inputs from Wi-Fi, Mi-Max or other technologies sitting in standard MiniCard slots. The module arbitrates access to the antenna systems from each wireless technology under command of an operating system and improves signal conditions for all wireless technologies being delivered to the antenna system.

Additional features and benefits of the present invention will become apparent from the detailed description, figures and claims set forth below.

### BRIEF DESCRIPTION OF THE DRAWINGS

The present invention will be understood more fully from the detailed description given below and from the accompanying drawings of various embodiments of the invention, which, however, should not be taken to limit the invention to the specific embodiments, but are for explanation and understanding only.

FIG. 1 is a schematic illustration of a mobile electronic device provided with a wireless communications subsystem;

FIG. 2 is a more detailed diagram of the system of FIG. 1;

FIG. 3 is a more detailed diagram of a portion of the antenna subsystem 213 of FIG. 2;

FIG. 4 is a schematic diagram of a dual band antenna frequency tuning circuit;

FIG. 5 is a diagram of a known phased array antenna with active elements that may be used in the present system;

FIG. 6 is a diagram of a phased array antenna with passive elements;

FIG. 7 is a diagram comparing radiation patterns for an phased array antenna without beamforming and with beamforming;

FIG. 8 is a diagram of a combined module implementing a wireless control module for a laptop computer;

FIG. 9 is diagram of one embodiment of an antenna subsystem;

FIG. 10 is a plot of a phased array antenna pattern in one mode of operation;

FIG. 11 is a plot of a phased array antenna pattern in another mode of operation;

FIG. 12 is a plot of a phased array antenna pattern in a further mode of operation;

FIG. 13 is a plot of a phased array antenna pattern in still a further mode of operation; and

FIG. 14 is a performance metric plot illustrating QOS application mode selection criteria.

### DETAILED DESCRIPTION

Those of ordinary skill in the art will realize that the following detailed description of the present invention is illustrative only and is not intended to be in any way limiting. Other embodiments of the present invention will readily suggest themselves to such skilled persons having the benefit of this disclosure. It will be apparent to one skilled in the art that these specific details may not be required to practice to present invention. In other instances, well-known circuits and devices are shown in block diagram form to avoid obscuring the present invention. In the following description of the embodiments, substantially the same parts are denoted by the same reference numerals.

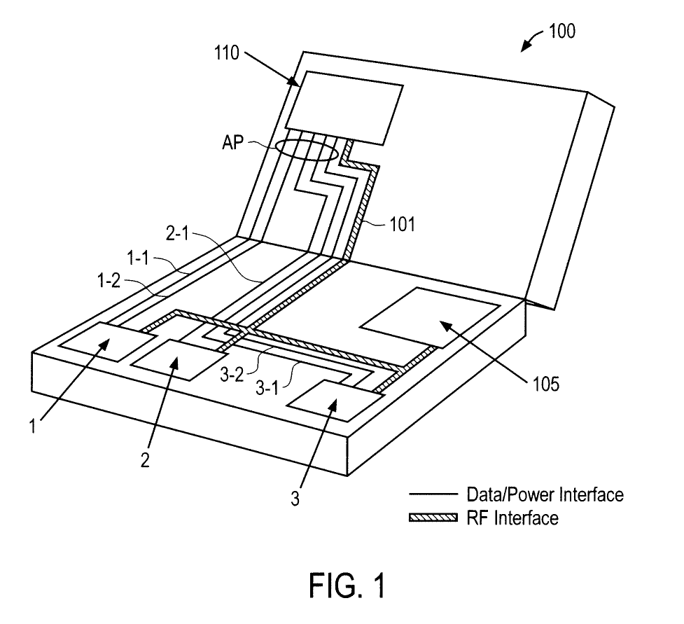

A schematic illustration of a mobile electronic device provided with a wireless communications subsystem is shown in FIG. 1. In this example, the host platform is a laptop computer 100. There are three wireless modules 1, 2 and 3 installed inside the platform, representing any combination of wireless technologies such as Bluetooth, WiFi, WLAN, etc. These wireless modules have various number of antenna ports. For instance, wireless module 1 has two antenna ports 1-1 and 1-2, wireless module 2 has one antenna port 2-1, and wireless module 3 has two antenna ports 3-1 and 3-2. A data and power interface exists between all of the wireless modules and the host platform electronics such as a host processor 105. The data and power interface 101 may be parallel and/or serial (such as a Universal Serial Bus), depending on the nature of the wireless module. The antenna ports, designated collectively by the reference designation AP, are connected to a unit 110 for manipulation of RF signals (including in this example a 3G Module Controller and Subsystem), typically via coaxial cable. The unit 110 provides a matrix switch function between the wireless module antenna ports AP and any one of a number of antenna subsystems (not shown) on the unit 110. It also provides an efficient common RF ground inside the top cover of the laptop 100 (i.e., the display area). As explained in greater detail below, the matrix switching allows various antennas to be selected for any of the wireless modules based on the operating band, polarization of the antenna, multiple antenna requirements such as a directive array or MIMO, noise reduction due to proximity of other electronics in the laptop, etc. Each antenna subsystem may have a selective center frequency, a specific polarization (horizontal/vertical/right circular, left circular), be operated as an active element or a passive element/radiator, etc. In addition, the gain (scaling factor) and phase of each element may be adjusted such that an adaptive array can be formed from a subset of the antenna elements on the unit 110.

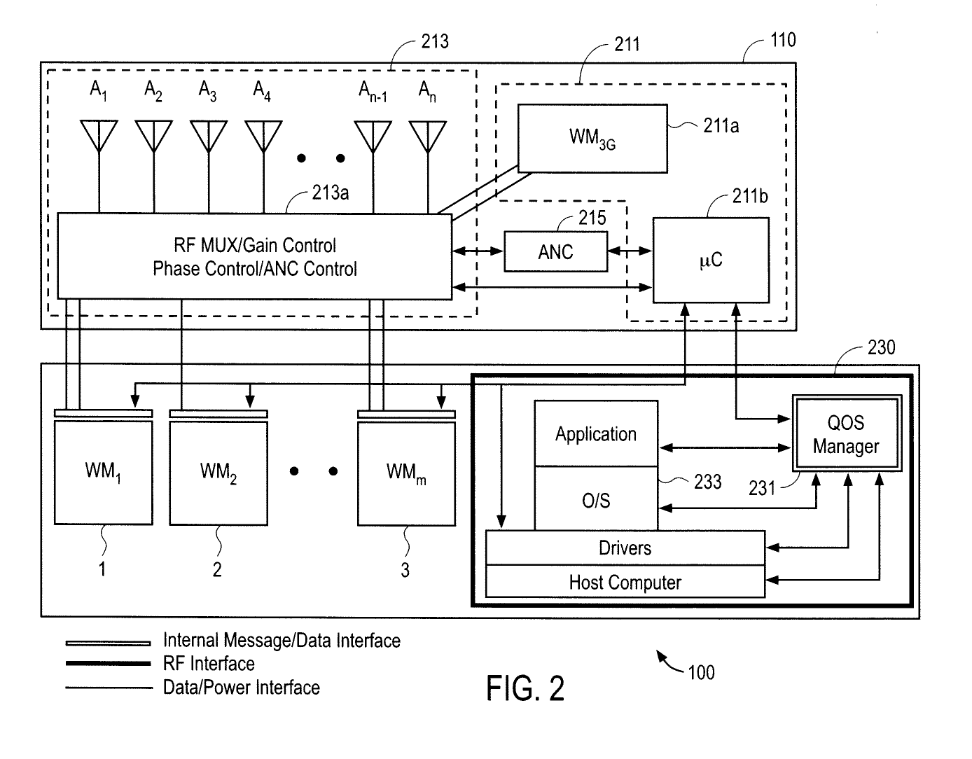

A more detailed diagram of the system of FIG. 1 is shown in FIG. 2. The system as described is comprised of five main sections or subsystems: a 3G module/system controller subsystem 211; an antenna subsystem; a grounding/coaxial connection subsystem 213; an Adaptive Noise Cancellation subsystem 215 (optional); and software 231 on the host platform 230 to interface the wireless devices to the host computer and to provide a control interface to the wireless controller subsystem 211. Each of these subsystems will be described in greater detail.

The 3G module and controller subsystem 211 may be integrated onto a single PCB (solid or flexible) situated in the display area of the PC as close to the antenna system 213 as possible. The controller 211 delivers duplex signaling from all wireless devices (including its own built in 3G device 211a) to the antenna system. The controller can therefore overcome cable loss or noise insertion in the system between the other wireless modules in the base of the unit 100 and the controller 211 and improve the signal levels and quality prior to delivery to the antenna system 213. The controller 211 can also cancel noise from the host platform entering the antenna system 213 prior to the receive signals being delivered to the wireless modules 1, 2, 3. The controller 211 will provide a digital signaling interface to the host device 230 so that the operating system 233 may choose the desired wireless service. In addition, it will provide power to operate the active devices such as microcontroller 211b, switches (not shown), etc. The controller 211 will deliver the service through a physical high speed interface to the host 230. The controller 211 will also manage any conflicts between baseband signaling from any of the wireless modules 1, 2, 3.

The unit 110 may be designed to accept various inputs from mini PCI Express (mPCIe) wireless services cards located in the main bay slots of the laptop computer 100. The unit 110 preferably presents a nominal matched impedance (i.e. 50 Ohms) to these services in order to maintain maximum signaling efficiency by minimizing losses. In one embodiment, the unit 110 accepts an external transmit input from each of the bay slots and ensures that this signal level does not cause damage to the controller 211, power supplies or antenna system 213. The controller may also balance thermal signatures to ensure that ambient temperatures or spot temperatures in proximity to sensitive components such as displays do not affect the performance of the system.

The controller 211 preferably also contains a wireless module 211a and operates in accordance to regulatory and industry (GCF/PTCRB/CTIA/CDG) requirements for 3G services (or later services, such as 4G, etc.). The controller 211 is responsible to connect antenna systems for the 3G system as well as alternate services resident in the base mPCIe slots. The controller 211 may accept commands from the operating system 233 in order to arbitrate active services (i.e., 3G or others). The controller 211 may also determine its own quality of service metrics to assist or override the service preferences provided from the operating system 233. Preferably, the unit 110 uses solid state inputs for other RF inputs and antenna system connections, thereby providing maximum impedance load stability and minimal insertion loss. The unit 110 may have the ability to measure and buffer signal levels and quality for connected services for mPCIe inputs as well as 3G outputs.

The controller 211 may allow for a “no-stuff” option on 3G. This would mean that non 3G services could function through a “blank” 3G controller module—maintaining the overall subsystem concept even though 3G is not present. The user or a service shop could at a later time insert a 3G wireless module to update the system.

The antenna subsystem 213 is also connected to the controller 211. It provides antenna functionality for wide range of wireless communication standards and, optionally, smart antenna functionality and the sensing means to implement Adaptive Noise Cancelling functionality (ANC 215).

The antenna system 213 may consist of a single or multiple elements that may be on a single substrate or multiple substrates. It is a known physical element that PC manufacturers can design the industrial design or physical features around. The intent of the antenna system 213 is to consolidate multiple services reducing the complexity of designing numerous separate antenna systems into a single end user device. In the illustrated embodiment, the antenna system connects to the 3G module/controller 211 but services all wireless inputs. It is designed to minimize size and weight while maximizing performance and minimizing the impact from electromagnetic noise from the host platform. The antenna system 213 may be a standard design that may require slight tweaking for each host platform due to interactions from the physical environment. In one embodiment, the antenna system is steered, fed and controlled by the 3G module/controller 211.

The antenna subsystem includes an RF MUX and signal conditioning block 213a (“RF MUX”). One function of the RF MUX 213a is to perform antenna switching. One known technique for RF switching uses PIN diodes. Other techniques use relays, GaAs FET transistors, etc. These or other similar known techniques can be used to implement a Matrix switch or MUX which can interconnect N wireless modules with M antennas. In one embodiment, the RF MUX 213a is an M×N RF switch. Signal conditioning functions of the RF MUX 213a include, for example, gain control, phase control, and automatic noise cancellation, described below.

The entire subsystem, centered around the 3G module/controller 211, is designed to ensure high efficiency connections from other wireless services within the host device. To this end, the grounding system in the host mPCIe slot area is designed to minimize common mode and differential noise entering the system. In an exemplary embodiment, the 3G module/controller 211 is placed in the lid of the laptop device 100 and is properly grounded to the system to minimize noise. Specific coaxial cabling specifications may include recommendations for cable types to improve insertion loss and minimize host noise intrusion for radiated or conducted sources. Optionally, the grounding system may include an antenna counterpoise system that allows for maximum efficiency while minimizing interference in the system. Such a counterpoise system helps ensure that the antenna system 213 when actively transmitting does not impact the performance of the main system due to excessive radio frequency interference (RFI).

Since the antenna subsystem 213 is located is close proximity to the electronics of the laptop computer 100 or the small form factor device, it is susceptible to the Electromagnetic Interference (EMI) generated by the digital electronics in these platforms. Considerable radio noise is generated by Personal Computers (PCs), as well as other portable computing devices. The noise created by these devices can interfere with the reception of signals by devices such as Wireless Wide Area Network Adapters, thereby reducing the sensitivity of the adapter and hence the range to the base station. The interference can be reduced by suppressing the noise at the source through improved design of the noise emitting electronic device. Alternatively, the noise can be reduced by choosing an antenna for the receiving device which isolates the antenna from the computer using distance (i.e., remote cable connection) or other means. However, these solutions have not been effective because of the reluctance of device manufacturers to increase product cost and the reluctance of users to use a remote cabled antenna.

A common problem with both PCMCIA and OEM wireless modules is that host generated noise can cause desense of the modem on one or more channels of the wireless data service. Desense refers to host generated Electro-Magnetic Interference (EMI) increasing the effective level of the noise floor and reducing the effective sensitivity of the receiver. Measurements have shown that desense in the laptop environment for the PCS band can be as high as 19 dB and for the 850 MHz band can be as high as 30 dB. The desense typically arises from digital clock noise generated by the computing device. The clock noise creates harmonics and other spectral components which lie within the bandwidth of the radio channel being used. If these spectral emissions occur within the channel being used for data communication, then problems of interference can occur. The emissions are strong enough to significantly degrade the input sensitivity of the receiver, even though their strength is low enough to meet regulatory emission requirements.

Most common current paths within an electronic device (such as a personal computer) consist of I/O cables, printed circuit board (PCB) signal traces, power supply cables, and power-to-ground loops. Each of these current paths can function as an antenna which radiates electric and magnetic fields. Interaction of these fields with other signals constitutes EMI. The magnitude of the EMI is a function of several characteristics of the transmitted signal—such as frequency, duty cycle, and voltage swing (i.e., amplitude). If the signal is non-periodic (such as hardware with a microcontroller which references RAM, Flash, I/O devices, control lines, displays such as LCDs, etc. in a time varying fashion), the Fourier Series representation of time domain digital signals f(t) would contain terms for a wide range of frequency components such as fundamental frequencies and all of their harmonics. In a typical PCMCIA or OEM installation, the signal spectrum near the logic boards would appear to be fairly wideband in nature and comprise a large number of individual spectral peaks whose amplitude would vary in time with the function being performed by the digital logic of the board.

The frequency spectrum generated by the high clock speeds and sharp edges of clocks in modern digital devices can extend well into the GigaHertz region. As such, these signals may be within the allocated bandwidth of commercial communication services. As previously mentioned, these signals may be relatively low in amplitude to satisfy the requirements of regulatory emission levels. However, these signals are quite strong when compared to the Received Signal Strength Indication (RSSI) of wireless network transmissions. For example, the RSSI from a base station may be in the order of about −85 dBm, but the level of interference from nearby digitally generated noise may be in the order of −80 dBm. As is evident, a −5 dBm signal to noise ratio results in this example and would degrade the overall wireless network performance.

Known automatic noise reduction techniques may be applied in the context of the present system to mitigate the effects of platform-generated noise on wireless signal reception. One such technique is described in U.S. Pat. No. 6,968,171 and U.S. Patent Application 20060030287 of the present assignee, both of which are incorporated herein by reference. As described therein, a receiver is provided with a far range receiving section that is configured to sense a desired signal having near field noise. The receiver further includes a near range receiving section configured to sense a near field noise reference signal. An adaptive noise canceller (ANC) of the receiver is configured to detect the magnitude of an error vector from the far range receiving section and adjust the phase and gain of the near field noise reference signal in response thereto. Accordingly, the ANC is configured to generate a corrected near field noise reference signal that is added to the desired signal with an adder. The near field noise is canceled by the addition of the corrected near field noise signal. The ANC uses a least mean square technique to determine the amount of correction needed.

Software 231 is provided on the host platform to interface the wireless devices to the host computer, and to provide a control interface to the wireless controller subsystem 211. It also collects various metrics from the various wireless modules 1, 2, 3 (i.e. WiFi, Bluetooth, WLAN, WiMAX, etc.) that are used in a Quality of Service (QOS) application to drive the Adaptive Noise Cancelling functionality 215 and to drive smart antenna beamforming functionality as described more fully below.

The QOS Manager 231 is a software/Firmware application which can run on the host computer, although it is possible to run it on the microcontroller 211b in the 3G Controller Subsystem 211. This application retrieves various information from the wireless modules 1, 2, 3 operating in the platform and configures the antenna subsystem 213 to achieve a specific goal. This goal could be a single goal or combination of goals such as: 1. Minimize the power consumption of the wireless modules 1, 2, 3 by selecting the wireless module which will consume the least energy than can still support the application running on the user platform; 2. Select the wireless module which has a specific level of performance required to meet the user application requirements, such as the need for some minimum net data rate; 3. Configure the antenna module 213 such that a single antenna is used for the wireless module, and one or more performance parameters are optimized by selecting the antenna mode which yields the best overall performance.

This optimization may be accomplished in various ways. In one scenario, a vertically polarized antenna and a horizontally polarized antenna are selected, and the operating frequency is programmed to be the nominal operating frequency of the wireless module; then switching is performed between the vertical and horizontally polarized antenna, selecting whichever antenna yields the highest signal strength. In another scenarios, other performance parameters may be optimized in this manner, such as Error Vector Magnitude (EVM), Frame Error Rate (FER), Bit Error Rate (BER), etc.

Instead of configuring the antenna module such that a single antenna is used for the wireless module, with one or more performance parameters being optimized by selecting the antenna mode which yields the best overall performance, the antenna module may be configured such that a phased array antenna is used for the wireless module. One or more performance parameters are optimized by steering the antenna main lobe (sweeping the scan angle) and selecting the scan angle that yields the best overall performance. This optimization may be accomplished in various ways. In one scenario, the phased array antenna is configured using the RF MUX 213a and the operating frequency is programmed to be the nominal operating frequency of the wireless module; then the scan angle is swept and the scan angle is selected that yields the highest signal strength. This optimization may involve selecting two, three, or more elements in the array A₁-Aₙ and selecting different element separations. The number of elements, element separation and scan angle that yields the highest signal strength would be selected. In other scenarios, other performance parameters may be optimized in this manner, such as Error Vector Magnitude (EVM), Frame Error Rate (FER), Bit Error Rate (BER), etc.

The wireless modules 1, 2, 3 are connected to the host computer 230 over a common data bus architecture such as USB, PC Card (PCMCIA), or the like providing a data bus 201. They may also be connected directly to individual I/O ports on the platform (i.e. RS-232). The QOS application 231 running on the platform host can access various information from the wireless modules 1, 2, 3 (such as RSSI, EVM, Frame Error Rate, Bit Error Rate, current consumption, etc.) through the data bus 201. Having gathered this information, the QOS Manager 231 can then configure the antenna array A₁-Aₙ via the microcontroller on the 3G Controller Subsystem 211. This configuration could range from very simple to quite complex depending on the nature of the wireless module.

For example, knowing that wireless module number 2 is a Bluetooth device, simply selecting a single antenna and programming the operating frequency of the antenna could suffice for this case. In another case, wireless module 1 may require three antenna elements to operate at 2.4 GHz in a MIMO configuration. In this case, the microcontroller 211b would configure the RF MUX 213a such that three antenna were selected and the operating bands of the elements would be selected to be 2.4 GHz. In yet another case, wireless module 3 may initially operate in GSM/GPRS mode at 1.9 GHz. Although the signal strength may be very high it could encounter a poor EVM metric. In this case, the QOS manager 231 would direct the microcontroller 211b to operate in the phase array mode and select the array antennas to operate at 1.9 GHz. It would then sweep the scan angle to minimize the EVM metric. This could be done using a brute force scan angle sweep, or the scan angle could be adoptively swept using an adaptive algorithm such as Least Squares or Kalman to select the optimum scan angle.

The microcontroller 211b performs a number of functions, but these are generally associated with configuring the RF MUX 213a (including gain control/phase control) and the ANC 215 under the direction of the host computer 230, e.g., from the QOS Manager 231. However, the microcontroller 211b can communicate via other mechanisms. For example, the microcontroller 211b can establish communications with other applications on the host computer 230 where it is advantageous for these applications to have a more intimate control over the antenna subsystem 213. Some of these means cannot be foreseen at this time, but an interface protocol to the microcontroller 211b such that the antenna subsystem 213 may be configured as desired. This is essentially a device driver interface.

The microcontroller 211b can establish communications with any of the wireless modules 1, 2, 3 on the host computer platform 100 where it is advantageous for these applications to have a more intimate control over the antenna subsystem 213. This could provide means whereby the antenna subsystem 213 could operate in a plug and play mode where it attempts to discover which wireless modules are available, what their antenna needs are, and configures itself to provide the required antenna functionality.

Also, the host computer operating system 233 can establish communications with microcontroller 211b in a plug and play fashion to determine how this resource can be utilized by other hardware and/or software under its control.

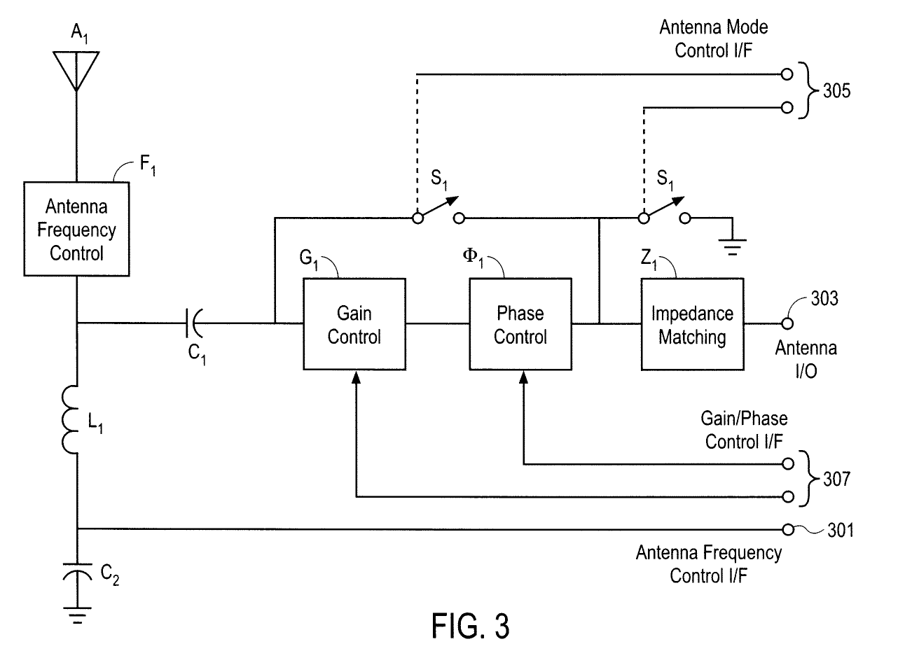

A more detailed diagram of a portion of the antenna subsystem 213 of FIG. 2 is shown in FIG. 3. The antenna subsystem 213 may be based on what may be regarded as a “universal antenna element” consisting of an antenna (A1), and impedance matching network Z1 to match the antenna impedance to the antenna input/output 303 such that the antenna input/output impedance appears as a standard input impedance (e.g. 50 Ohms). An antenna frequency control interface provides a DC control signal 301 to the antenna frequency control block F1 such that the antenna center frequency may be controlled through this control signal. The DC control signal can act as a logic level selecting one antenna center frequency or another, or it may be continuously variable such that the antenna center frequency may be swept continuously over a range of frequencies. A capacitor C1 acts as a DC block isolating the antenna and the antenna frequency control block F1, and components L1/C1 act as an RF block to decouple RF energy from the DC control line 301. A phase control block Φ₁ and a gain control block G₁ are provided following the impedance matching block. These blocks are configured using a gain/phase control interface 307. An antenna mode control interface 305 allows the antenna element to be selected or unselected.

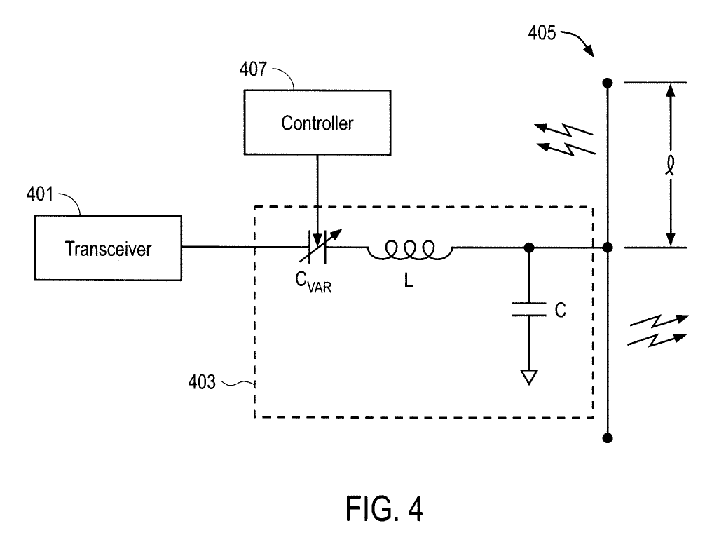

Frequency control of the antenna may be performed as described in U.S. Pat. No. 6,697,030 of the present assignee, incorporated herein by reference. Referring to FIG. 4, the system includes a transceiver 401, a matching network 403 and an antenna 405. The matching network has a variable capacitor CVAR, an inductor (L) and a second capacitor (C) and is operable to tune the antenna to the transceiver at both a first and second frequency. The value of the variable capacitor (CVAR) is chosen to tune the antenna 405 at the first frequency and the second frequency such that the system can be used to transmit and receive electromagnetic energy over two bandwidths. The values of the variable capacitor, the inductor, and the second capacitor are controlled by a controller 407 to minimize the standing wave ratio of the system at both the first frequency and the second frequency.

Referring again to FIG. 3, the gain correction block G₁ provides variable gain scaling between the Antenna I/O port 303 and the antenna A₁. This scaling may be fixed or variable. For example, in a fixed step attenuation mode the gain correction could consist of selectable attenuation steps of 0, 1, 2, 3, 4, . . . , 10 dB. In a continuously variable mode the gain could be adjusted from, say, 0 dB to 10 dB using an analog control voltage. There are numerous ways to implement a gain control block. In this particular application, a gain control block with adjustable gain of=1.0 (i.e., an adjustable attenuator) is suitable. Adjustable attenuators can be realized in a number of forms such as PIN diode attenuators or GaAs MESFET attenuators. FET-based attenuators are available in small surface mount packages from a number of vendors, such as Skyworks (the AV108-59 GaAs IC 35 dB Voltage Variable Attenuator), AM-COM (AT-255 GaAs MMIC Voltage Variable Attenuator) and others.

For matched broadband applications, especially those covering low RF frequencies (to 5 MHz) through frequencies greater than 1 GHz, PIN diode designs are commonly employed. The circuit configurations most popular are the TEE, bridged TEE and the PI. All these designs use PIN diodes as current controlled RF resistors whose resistance values are set by a DC control, established by an AGC loop. PI configurations can be implemented in a number of configurations (e.g., the 3-diode and the 4-diode configurations) using commercially available parts such as the model HSMP-3816 quad PIN diode from Avago Technologies.

The impedance matching element Z₁ consists of various circuit elements to match the RF port of the wireless module to the RF MUX 213a such that the antenna subsystem 213 looks like a constant 50 Ohm impedance, eliminating the need to match the wireless module.

The phase control block Φ₁ provides variable phase shifting between the Antenna I/O port 303 and the antenna A₁. This phase shift may be fixed or variable. For example, in a fixed step phase shift mode the phase shift could consist of selectable phase delays of steps of 0°, 10°, 20°, 30°, 40°, . . . , 180°. In a continuously variable mode the phase could be adjusted from say 0 degrees to 180° using an analog control voltage. Phase control can be realized by a number of means, such as with phase shifters. A phase shifter is a two-port network in which the phase difference between the input port and the output port may be controlled by a control signal. This phase shift can be digital in the sense that only predetermined discrete values can be selected (such as 22.5°, 45°, 67.5°, 90°, etc.), or it may analog in the sense that it is continuously variable over a range (such as 0° to 180°). The design of phase shifters is well known, and is described in detail in various references (see for example Inder Bahl and Prakash Bhartia, “Microwave Solid State Circuit Design,” John Wiley and Sons, Inc., 1988). Phase shifter modules are also available commercially from a number of vendors such as Mini-Circuits, MA-COM, etc. An example would be the JSPHS-1000 180° Voltage Variable phase shifter from Mini-Circuits of Brooklyn, N.Y.

It should be noted that a phase shifter with digitally selected discrete phase shifts could also be used in this application. If the discrete phase shifts are less than the 3 dB beamwidth of the phase array, then effective beam steering can be achieved with these discrete phase shifts. Discrete phase shifters can be implemented by a number of means such as switched line phase shifters, loaded-line phase shifters, switched-line reflective phase shifters, etc. They are readily available from a number of commercial vendors such as Mini-Circuits, MA-COM, etc.

Adjustable phase and gain control of individual elements as well as an ability to select elements of an antenna array allows a number of these individual elements to be combined into a “phased array structure” where the individual element gains and phases are adjusted to steer a main lobe or a beam null in a particular direction, as well as form the individual element beam patterns into a different pattern with advantageous characteristics. Such an antenna structure is generally described as a “Phased Array Antenna”. These can be implemented using active elements or it can be implemented with a combination of active and passive elements. The following subsections describe both active and active/passive elements.

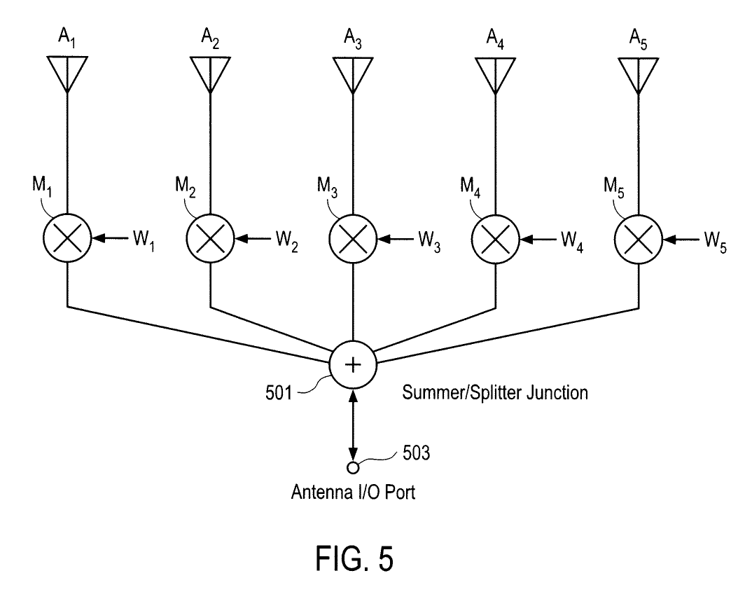

FIG. 5 is a diagram of a known phased array antenna A_{PA} with active elements that may be used in the present system. In this example there are five “active” antenna elements A₁-A₅ which have gain coefficients G1, G2, G3, G4, and G5. By active, it is meant that the individual antenna branches are connected to a summer/splitter junction 501 connected to an antenna I/O port 503. Assigned phase delays are φ1, φ2, φ3, φ4 and φ5. In FIG. 5, the antenna weights are assumed to be in their polar form:

wᵢ=Gᵢ·e^{jφ}i

Respective weighs wᵢ are applied to respective complex multipliers M₁-M₅. By properly selecting the “weighting” coefficients of each individual antenna element, the main lobe and/or the null can be steered in a particular direction.

Each of the antenna elements A₁-A₅ on its own has a uniform circular radiation pattern in the x-y plane. Such an antenna when installed in a platform such as a laptop will provide an internal wireless modem with an omni-directional radiation pattern, which would be insensitive to how that laptop was oriented in the x-y plane. Situations do arise when such an omni-directional radiation pattern may not be desired. Some of these situations may be: 1. The laptop is situated in an environment where the received signal level is poor to marginal, resulting in degraded performance (dropped packets, low throughput, etc.); 2. There may be in-band noise sources nearby which create co-channel interference which could result in degraded performance, even to the point that the wireless communication link cannot be maintained.

In case 1, a phased array antenna can be used to modify the shape of the antenna radiation pattern such that it provides higher gain in the direction of a base station associated with the wireless device inside the laptop. This would be done by having the RF MUX 213a (FIG. 2) select two or more of the antenna subsystem elements and combining them such that a linear array is formed. If we assume for the moment that the elements have uniform gain (unity gain in this case) and only vary the phase of each antenna subsystem element, then the main lobe of the array can be steered toward the direction which provides the highest signal level, or some other metric such as the error vector magnitude (EVM) of the baseband signal.

Using the variable phase delays in each of the antenna subsystem elements, the control processor 211b (FIG. 2) can essentially scan the main lobe +90° to −90° degrees in order to achieve the highest signal strength and/or the best Error Vector Magnitude for the radio channel it is tuned to. This scheme may additionally compensate for the presence of other electrically conducting surfaces in the laptop computer that may interact with the actual antenna elements in the antenna subsystem. These conducting surfaces may act like parasitic elements and disturb the radiation pattern of the antenna subsystem so as to actually degrade the performance. By steering the active elements through various angles, it may be possible to steer the main lobe towards the base station and improve the signal quality.

As was discussed earlier, electromagnetic interference can be generated near the laptop and its integral antenna subsystem and create co-channel interference which may degrade the desired received signal. Just as one steers the main lobe towards a base station to improve signal strength, beam patterns nulls can be steered to towards the source of interference such that they become heavily suppressed. For example, a simple two element phased array can steer nulls on the order of 40 dB below the main lobe gain. This could allow communications to be supported in an environment in which it might not normally be possible.

Depending on the particular characteristics of a phased array antenna subsystem, drastically different radiation patterns can be realized. Various characteristics may be chosen to achieve the best radiation pattern for a particular application. For example, the spacing of the antenna elements may be chosen to be 0.5 wavelengths or 0.25 wavelengths. The important point to note, however, is that by using antenna subsystem consisting of a sufficient number of antenna elements arranged in a linear fashion, a very flexible antenna system can be achieved. It can allow a single antenna element to be connected to a wireless module such that a traditional omnidirectional radiation pattern results, or allow various elements to be combined in a phased array pattern and configured to achieve a highly directive radiation pattern, thereby providing a higher gain main lobe in a particular direction or steering a null in the beam pattern towards an undesired interferer.

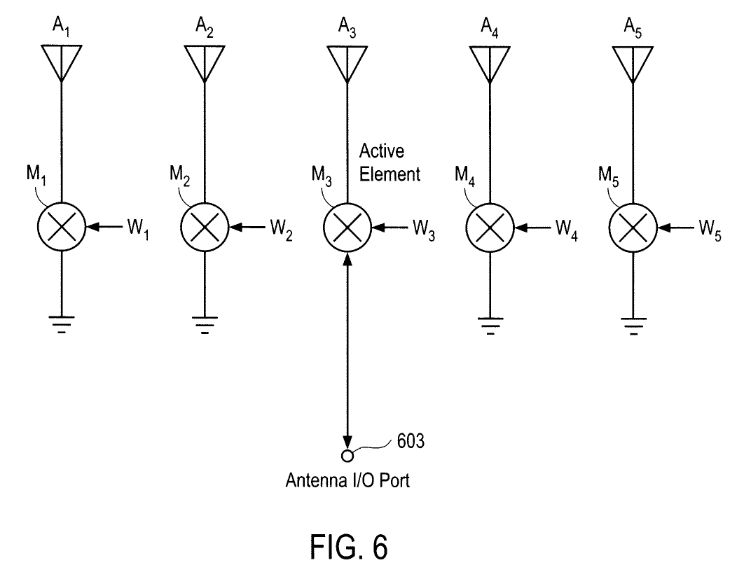

It is also possible to have only one active element in phased array, and to have the remaining elements be passive or parasitic in nature. A passive radiator or parasitic element is a radio antenna element which does not have any wired input. Instead, it absorbs radio waves radiated from another active antenna element in proximity, and re-radiates it in phase with the active element so that it adds to the total transmitted signal. This manner of operation will change the antenna pattern and beam width. Parasitic elements can also be used to alter the radiation parameters of nearby elements. An example of this is to place a parasitic microstrip patch antenna above another driven patch antenna. This antenna combination resonates at a slightly lower frequency than the original element. However, the main effect is to greatly increase the impedance bandwidth of the antenna. In some cases the bandwidth can be increased by a factor of 10. Referring to FIG. 6, in the present example, of antenna elements A₁-A₅, all but one of the active elements, A₃, is connected to ground. The active antenna element is connected to an antenna input port 603. The actual gain and phase of the elements is adjusted using the multipliers M₁-M₅ so that the overall array represents a phased array antenna.

Apart from the ability of a phase array antenna to perform beam steering, a phased array antenna may also be controlled to perform beamforming, i.e., to form the individual element beam patterns into a different pattern with advantageous characteristics.

One of the simplest methods of beam forming is to simply “weight” the individual branches of the phased array antenna before summing. This provides the ability to shape the main lobe and suppress the side lobes. In all cases, the main lobe of the shaped beam will be broader than that of a uniformly weighted array, but the sidelobes can be suppressed dramatically. In order to illustrate this, consider the example of a five element phased array with zero phase shift in all of the elements. This arrangement will create a symmetric broadside antenna pattern. In the case of uniform branch weights, this creates a classic sin(x)/x beam pattern in which the first side lobe is down from the main lobe by −13.2 dB. Next, consider the case where the branch weights are weighted by a Hamming Window which is symmetric about the center branch, resulting in the following antenna weights: W(1)=0.3098; W(2)=0.7696; W(3)=1.000; W(4)=0.7696; W(5)=0.3098.

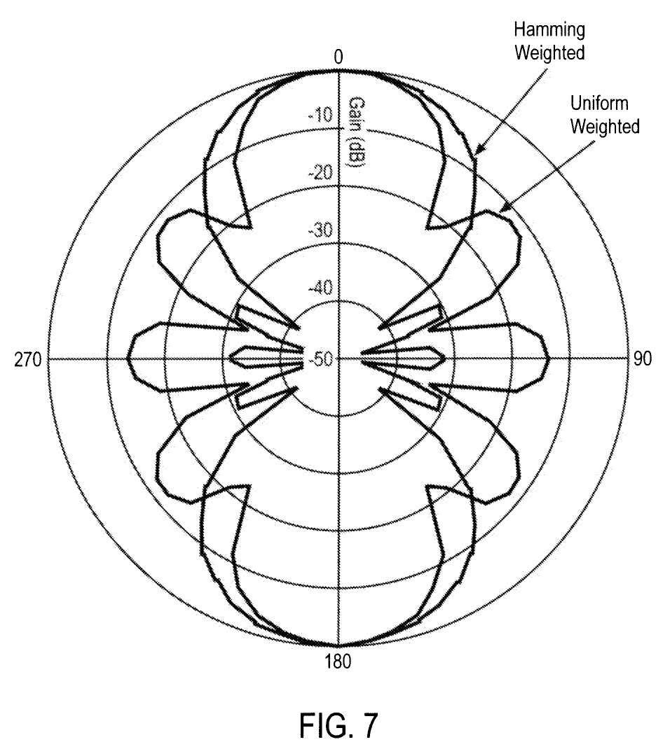

A comparison of the phased array antenna beam pattern for the uniformly weighted phased array antenna and the Hamming weighted phased array antenna is shown in FIG. 7. For the uniformly weighted array in the example, the 3 dB beamwidth is about 35 degrees and the first side lobe is down from the main lobe by −13.2 dB. In the Hamming weighted phased array antenna, the main lobe is wider at about 50 degrees and the first side lobe is down from the main lobe by about −31 dB. The advantage of beam forming in this case would be very good suppression of interferers which are off axis by over 40 degrees. Whereas the example demonstrates beam forming without beam steering, beam steering could be applied in addition to beam forming and the advantages of both could be achieved.

### Example 1

### Antenna Array for a Multiband Application

The nominal operating frequencies for various wireless services to be supported are shown in the following table, along with their corresponding wavelengths.

| Nominal Center Frequency (MHz) | Nominal Wavelength (cm) |
|---|---|
| 800 (Cellular) | 37.5 |
| 1900 (Cellular) | 15.8 |
| 2400 (WiFi, Bluetooth) | 12.5 |
| 2100 (3G) | 14.2 |

For multiband applications, one must choose a sufficient number of antenna elements and choose antenna element spacing such that the array is flexible enough to offer flexibility across a wide range of operating frequencies. By providing a total of nine antenna elements etched onto a single printed circuit board and spaced in accordance with ¼ wavelength spacing, a sufficiently flexible array is achieved to enable operation across the required range of operating frequencies. The phase control required may be the order of 180 degrees maximum across the linear array. In this example, two antenna elements are provided at a spacing of 9.4 cm (1800 MHz), three antenna elements are provided at a spacing of 3.9 cm (1900 MHz), and four elements are provided at a spacing of 3.1 cm (2400/2500 MHz).

The overall length of the array may be about 12 cM. The elements can be operated as a phased array in cases where directivity/null steering is required, or the antenna elements may simply be directly connected to a MIMO transceiver. The size of the array allows for a substantial ground plane to be realized, which is an important consideration in maximizing the performance of each individual antenna subsystem element.

Depending on the orientation of the main radiation lobes in relation to the axis of the antenna element array, operation of the antenna array may be described as “broadside” or “endfire.” Computer modeling of the foregoing system reveals that, in the case of the 800 MHz configuration, sidelobe suppression of 6 dB may be obtained, as well as the ability to steer nulls. Good unidirectional endfire performance can also be realized, as well as additional main lobe gain from the use of two elements. In the case of the three element 1900 MHz configuration, sidelobe suppression of 10 dB may be obtained, as well as the ability to steer nulls. Good unidirectional endfire performance can also be realized, as well as additional main lobe gain from the use of three elements. In the case of the four element 2400/2500 MHz configuration, sidelobe suppression of about 12 dB may be obtained, as well as the ability to steer nulls. Good unidirectional endfire performance can also be realized, as well as additional main lobe gain from the use of four elements.

As illustrated in the foregoing example, various advantages of the present system mentioned previously are achieved in main part by operation of the antenna subsystem 213, the RF MUX 213a, and the controller 211b.

More particularly, improved Transmit and Receive performance is achieved for all wireless technologies built into the laptop computer (or other small form factor computing device) using a single antenna subsystem, with all of the antenna subsystem elements located on a single printed circuit board which provides a large ground plane for all antenna elements. Since all of the antenna elements and associated hardware are integrated onto a single board, it greatly simplifies the installation onto the platform, as well as simplifies the integration effort. Since the ground plane is already part of the controller subsystem, there is no need to ensure that the platform itself provides an effective ground plane for the antenna elements.

Isolation and control of path loss and phase loss between primary wireless engines and their respective antenna systems is achieved by having a standard RF interface characteristic, namely a nominal 50 Ohm resistive load. This allows for a common interface impedance all wireless modules and eliminates the need to match the RF port, as long as the wireless module has a 50 Ohm impedance. In this way the losses due to impedance mismatching are dramatically reduced, and the effort required to integrate the wireless module into the platform is greatly reduced.

Improved reuse and control of antenna systems within the platform may be achieved through the use of antenna elements which provide electrical band switching functionality. For example, the same element used for 1900 MHz operation could be electrically switchable between 1900, 2400, and 2500 MHz. In this way, the total number of antenna elements required for four band operation in Example 1 could be reduced from nine to five elements. Although the spacing between the three elements used to fabricate the phased array for 1900, 2400 and 2500 MHz might not be optimal, a substantial increase in the overall antenna performance could be achieved.

Improved control of multiple wireless technologies in one subsystem is achieved through the ability of the RF MUX 213a and the controller 211b to select a wide range of antenna modes. These modes may include, for example: 1. The simple case where a wireless module is connected to single antenna element; 2. The case where a phased array configuration is selected to achieve improved wireless module performance through improved antenna performance; and 3. The case where a wireless module that is capable of supporting MIMO can have each MIMO Port routed to an individual antenna element.

A better reference design framework for PC Original Equipment Manufacturer's (OEM's) to implement multiple wireless technologies with faster time to market and lower engineering development risk is achieved by the RF MUX 213a and the controller 211b being able to operate with multiple wireless technologies in an almost limitless number of combinations.

Simplification of the antenna subsystem platform installation/integration into the laptop or small form factor device is achieved by providing a flexible fully integrated antenna subsystem, minimizing the effort and expertise required by the platform manufacturer. By creating a complete integrated antenna system, the OEM need only connect the wireless module to a connector on the RF MUX Controller—all of the routing from the connector to the appropriate antennas is performed by the RF MUX functionality and the onboard microcontroller. There is no need to deal with the individual antenna elements, impedance matching, etc. Essentially, a complete modular plug-in antenna system is provided which can support multiple wireless technologies.

### Example 2

### Laptop Computer with Bluetooth, WiFi and 3G (HSDPA)

Using the foregoing teachings, Bluetooth, WiFi and 3G (HSDPA) modules were integrated with a laptop computer.

The Bluetooth chosen was an OEM module from Taiyo Yuden, the EYTF3CSTT Class 2 Bluetooth OEM Module. It has a single antenna connector, and the operating frequency is 2.402-2.48 GHz. It uses a USB interface.

The WiFi 802.11b/g module chosen was a Quatech WLRG-RA-DP101 OEM module. The operating frequency is 2.4-2.4835 GHz, and it uses a Compact Flash (CF) interface. This module has two antenna ports and supports receive diversity.

The 3G (HSDPA) module chosen was the Sierra Wireless MC8755 PCI Express MiniCard.

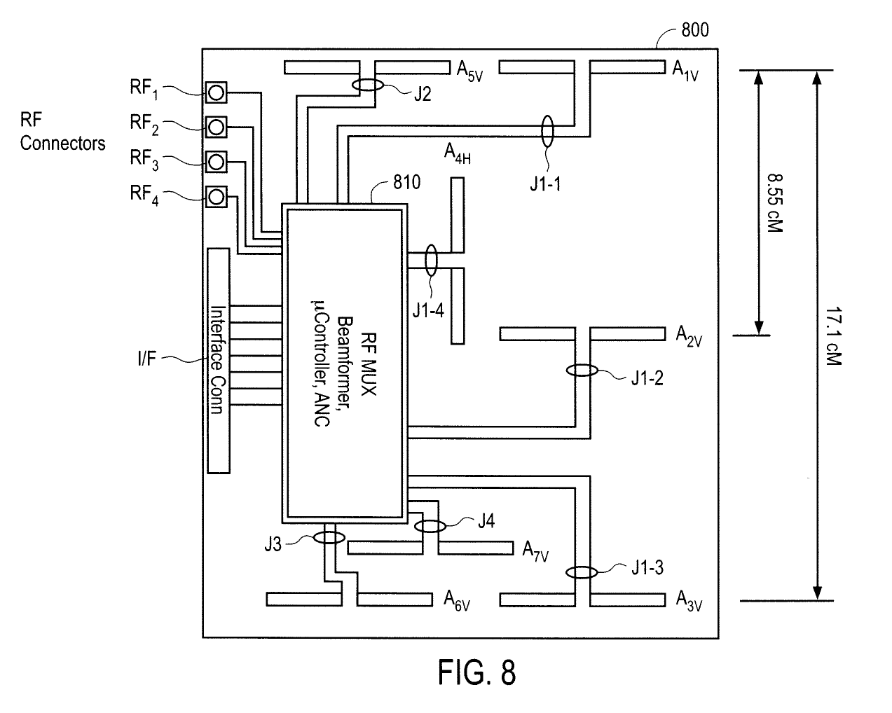

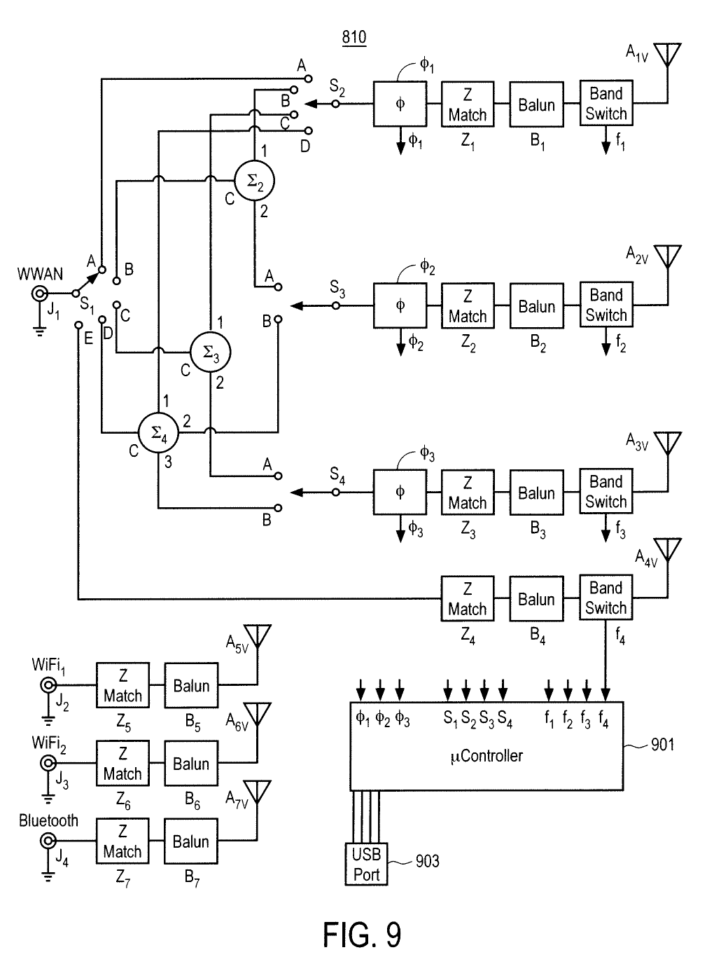

Referring to FIG. 8 and FIG. 9, a subsystem 800 was provided having four RF connectors RF₁-RF₄ (one for the 3G module, one for the Bluetooth module, and two for the WiFi module), and one interface connector I/F to interface to the host controller. An RF MUX/controller subsystem 810 was provided, including a microcontroller having beamforming capability. In this Example, no ANC subsystem was provided. An antenna subsystem was provided having seven antennas, as follows:

A_{1V} - Vertical polarized element for the 3G module
A_{2V} - Vertical polarized element for the 3G module
A_{3V} - Vertical polarized element for the 3G module
A_{4H} - Horizontal polarized element for the 3G module
A_{5V} - Vertical polarized element for the 802.11 b/g module
A_{6V} - Vertical polarized element for the 802.11 b/g module
A_{7V} - Vertical polarized element for the Bluetooth module

The combined module was fabricated with a flexible PCB material. The flexible PCB has advantages in that it can be placed on the back cover of a laptop display and held in place with an adhesive. Stripline antenna elements were formed on the flexible PCB material.

The antenna module implemented three wireless channels, for WWAN, WiFi, and Bluetooth, respectively. The WiFi module used two antennas as part of its Rx Diversity functionality, and these were hardwired to vertically polarized antennas A₅ and A₆ via connectors J₂ and J₃ respectively. The Bluetooth module was hardwired to antenna A₇ via connector J₄. The Wireless Wide Area Network (WWWAN) antenna consisted of four individual antenna elements A₁ to A₄, accessible via connectors J₁-J₄. The antenna elements themselves were band switchable under control of the microcontroller. Various subassemblies and switches were connected in the channel to provide a single element vertically polarized antenna, a single element horizontally polarized antenna, and fixed beam steering of combinations of elements to achieve broadside and endfire characteristics.

Referring more particularly to FIG. 9, a more detailed view is shown of the RF MUX/controller 810 of FIG. 8. Each of the antennas A_{1V}-A_{7V} (including antenna A_{4H}) was preceded by a balun (B₁-B₇) and an impedance matching element (Z₁-Z₇). In this Example, the impedance matching elements were fixed. In addition, each of the antennas A_{1V}-A_{4H} was preceded by a controllable band switch (f₁-f₄), and each of the antennas A_{1V}-A_{3V} was preceded by a controllable phase shifter (Φ₁-Φ₃). Control signals for controlling the band switches f₁-f₄ and the phase shifters Φ₁-Φ₃ were provided by a microcontroller 901. The microcontroller 901 communicates with the host computer through a USB port 903.

A signal routing network 910 was provided in the form of switches S₁-S₄, controlled by the microcontroller 901, and signal splitters Σ₂-Σ₄. Depending on the position of the switch S₁, the WWAN signal at connector J₁ was applied either to one of the antennas A_{1V} and A_{4H}, or to a combination of antennas, as follows: A_{1V}/A_{2V}; A_{1V}/A_{3V}; A_{1V}/A_{2V}/A_{3V}. The four PIN diode switches (S₁-S₄) were used to select the following six WWAN antenna Modes:

| MODE | S1 | S2 | S3 | S4 |
|---|---|---|---|---|
| Single Element Vertically | A | A | X | X |
| Polarized Antenna | | | | |
| Single Element Horizontally | E | X | X | X |
| Polarized Antenna | | | | |
| 800/900 Broadside | C | C | X | A |
| 800/900 Endfire | B | B | A | X |
| 1800/1900/2100 Broadside | B | B | A | X |
| 1800/1900/2100 Endfire | D | D | B | B |

The switches S₁-S₄ performed all of the signal routing from the connector J₁ through the phase shifters Φ₁-Φ₃, impedance matching networks Z₁-Z₄, baluns B₁-B₄, and band switches f₁-f₄ to effect the desired antenna configuration. The switch blocks S₁-S₄ are under control of the microcontroller 901. The band switch blocks f₁-f₄ are used to switch the antenna elements so that they operate at the appropriate center frequency required for the 3G wireless module. Baluns B₁-B₇ are used to convert the unbalanced feeds to balanced feeds for the dipole antenna elements used in this example. If monopole elements are used, then the baluns B₁-B₇ would not be used but a counterpoise would be used for the element.

The band switching blocks f₁-f₄ are under control of the microcontroller 901. The phase shifting blocks Φ₁-Φ₃ select the phase delay required in the specific antenna elements to effect broadside or endfire mode in the phased array mode. The phase shifting blocks Φ₁-Φ₃ are under control of the microcontroller 901. The microcontroller 901 is a simple 8-bit microcontroller which controls the phase shifters Φ₁-Φ₃, band switches f₁-f₄, and switches S₁-S₄ under control of the QOS application 231 running on the host computer 230 (FIG. 2). In this case a standard USB bus interface 903 was used to obtain power from and to achieve a serial data communications interface with the host computer 230.

Two modes are supported, “simple mode” and “smart mode.” With suitable modifications, a third mode, “super-smart mode,” could be supported.

In simple mode, there is no beam steering. All the RF MUX/controller subsystem does is to switch the RF connectors to the antenna elements appropriate for the wireless module. It can also provide for bandswitching of the antennas. There is no beam forming or beam steering. The purpose of this mode is to simply allow the wireless modem integrator some flexibility in the antenna installation. If the OEM module supports MIMO, code running in this mode could select the antenna routing.

In smart mode, phase delays are provided for, but phase delays are fixed at 0 degrees and ±90 degrees. That is, the delays are switchable and not continuously variable. The gains are fixed for all elements, thus the gain blocks were removed from the circuit. In this mode, the 3G module operates at 850, 900, 1800, 1900 and 2100 MHz.

Super Smart Mode includes additional capabilities beyond those of smart mode. Instead of just being able to select between broadside and endfire phased arrays, super smart mode would provide beam steering and null steering, requiring continuously adjustable phase delays and gains. Beam Steering would further incorporate beam shaping to trade off phased array beam width versus integrated side lobe ratio. Adaptive Noise Cancellation would be included.

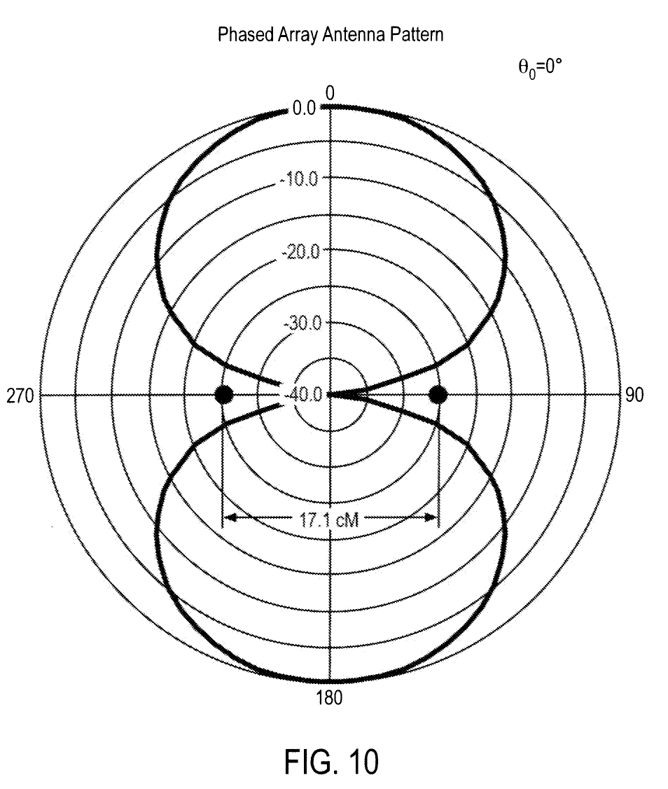

In the 850 and 900 bands, the microcontroller 901 uses vertically polarized elements A_{1V}, A_{3V}, and A_{3V}. In the broadside mode where the main lobe is at right angles to the array, only elements A_{1V} and A_{3V} are used. They had a spacing of 17.1 cm and were co-phased (0 degrees delay) and operated with equal gain. This manner of operation provides an antenna pattern as shown in FIG. 10.

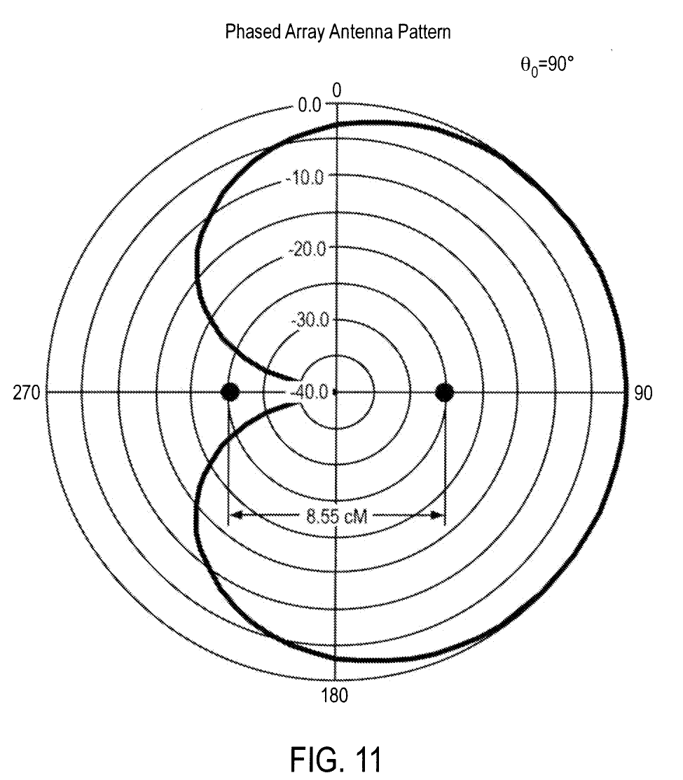

In the endfire mode, only two adjacent elements are used with a 90 scan angle and either A_{1V}/A_{2V}, or A_{2V}/A_{3V} are used as the active elements. They are spaced 8.55 cm apart. A 90 degrees phase difference and equal gains are used. This provides an antenna pattern as shown in FIG. 11. The endfire beam could be directed in the opposite direction using a phase shift of −90 degrees.

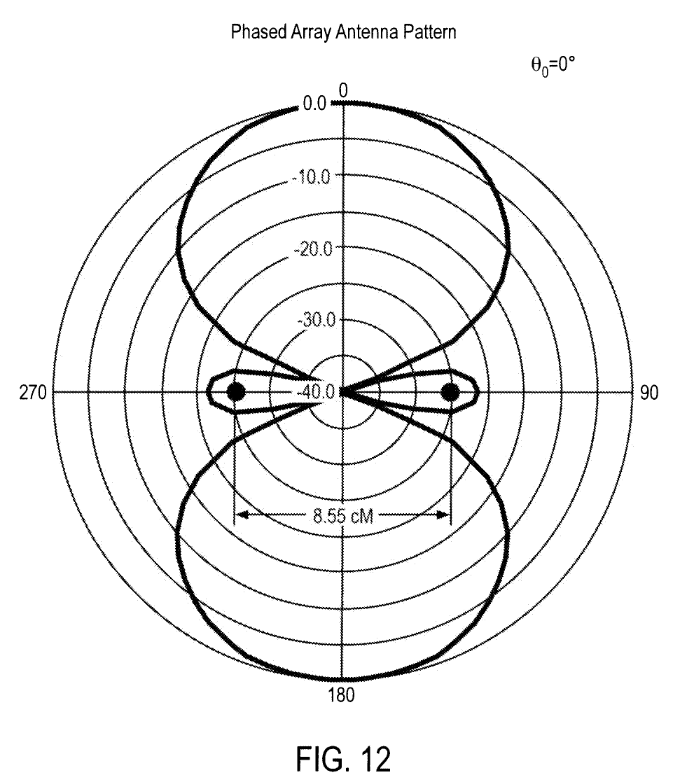

For the 1800/1900 MHz bands, the element spacing does not quite work out to quarter wavelength multiples, but its close enough to be effective. In the broadside mode where the main lobe is at right angles to the array, only elements A_{1V} and A_{2V} are used, although A_{2V} and A_{3V} could be used equally as well. The elements have a spacing of 8.55 cm and were co-phased (0 degrees delay) and operated with equal gain. This manner of operation provides an antenna pattern as shown in FIG. 12. With a steering angle of 90 degrees in broadside mode, good nulls are obtained at 90 degrees to the main lobe. The overall length of 17.1 cm yields an element spacing of 0.53 wavelengths, which is not exactly the 0.5 desired, but still yields quite good performance.

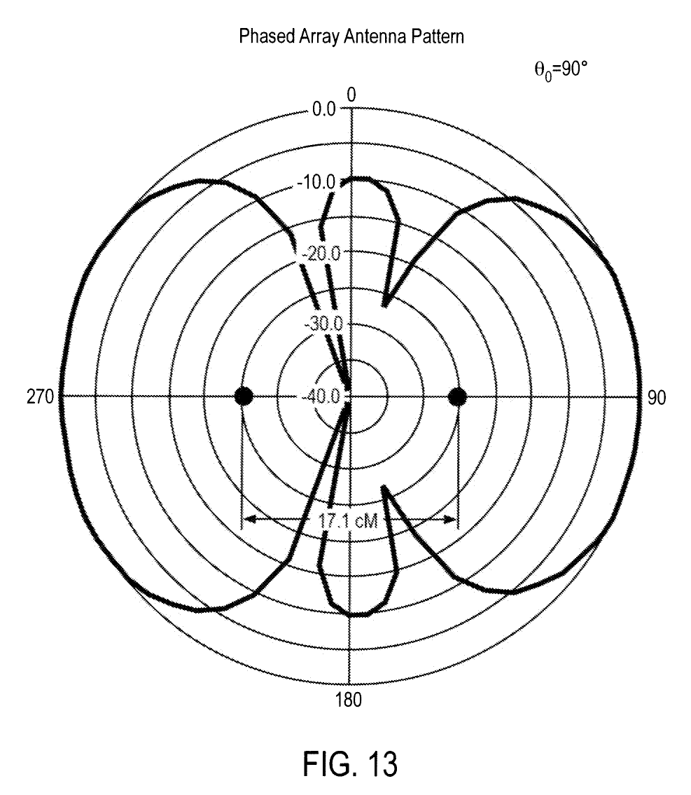

In the endfire mode, all three antennas A_{1V}, A_{2V} and A_{3V} are used as the active elements with a 90 degree scan angle. They are spaced 8.55 cm apart, which is about 0.53 wavelengths instead of the desired 0.5 wavelengths. A 90 degrees phase difference and equal gains are used. This provides an antenna pattern as shown in FIG. 13. In this case, the endfire is more or less symmetric in either direction so there is no need to direct it in the opposite direction.

Antenna A_{4H} is available in the event that a horizontally polarized antenna provides better performance over a single element vertically polarized element or a multi-element vertically polarized phased array.

The RF MUX/controller subsystem 810 contains the switch matrix S₁-S₄, which interconnects the various RF connectors with the various antenna elements, and the phase delay elements Φ₁-Φ₃, which effect the beam direction. The microcontroller 901 administers these functions under control of the QOS Manager application 231 on the host platform 230 (FIG. 2). The RF MUX/controller subsystem 810 would be customized for various applications and degrees of complexity required for the intended platform. In this Example, it is fabricated with switched delays rather than continuously variable delays, and without variable gain elements. For the Bluetooth and 802.11b/g modules, the RF connectors are connected to an impedance matching network and then directly to the corresponding antennas, since they are not steerable.

The RF/controller subsystem 810 was controlled in accordance with switch metrics that select from three modes: single element vertically polarized band switched; single element horizontally polarized band switched; and multi-element vertically polarized phased array band switched broadside/endfire mode. Impedance matching from 50 Ohms to the specific impedance of the antenna is performed.

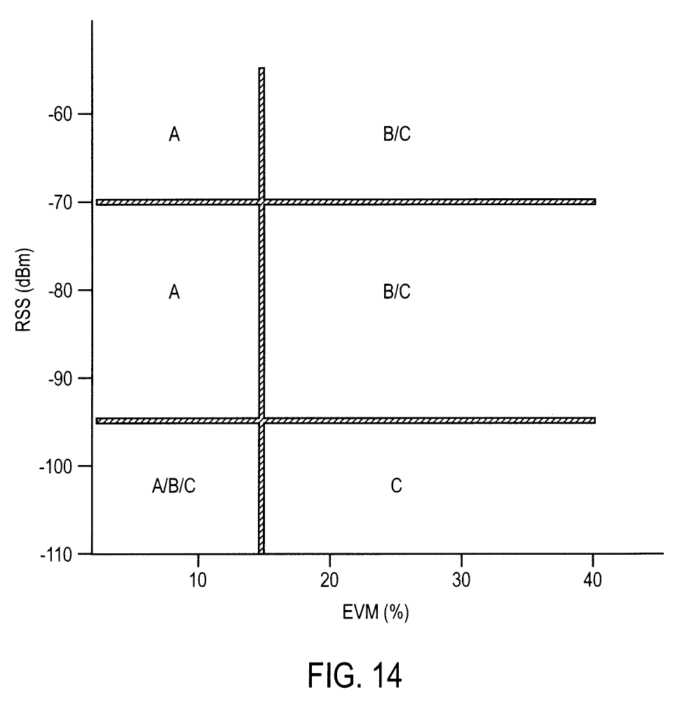

In this Example, a fairly simple QOS strategy is used. The microcontroller 901 judges the signal quality as follows. First, it determines the EVM for the particular channel it is receiving. Next, it determines the Received Signal Strength Indication of the channel it is receiving. Using selection criteria like those shown in FIG. 14, it would determine which antenna control mode it would use to maximize the receive signal performance. In FIG. 14, in region A, RSSI is strong and EVM is low for a single vertical element. Under these conditions, the recommended action is to continue use of a single vertically polarized antenna element. In region B, RSSI is low and EVM is low, indicative of low signal strength. Under these conditions, the recommended action is to change to a Horizontally polarized antenna element. In region C, signal strength is low and/or EVM is high. Under these conditions, the recommended action is to try a phased array configuration in an attempt to increase performance. The antenna is stepped through the broadside or endfire modes and the mode which results in the best RSSI and/or EVM is selected. The regions A, B and C are not mutually exclusive. Where regions overlap, multiple different measures are attempted to determine which antenna control mode to use to maximize the received signal performance.

While particular embodiments of the present invention have been shown and described, it will be obvious to those skilled in the art that, based upon the teachings herein, changes and modifications may be made without departing from this invention and its broader aspects. Therefore, the appended claims are intended to encompass within their scope all such changes and modifications as are within the true spirit and scope of this invention.

What is claimed is:

1. A mobile electronic device comprising a wireless communications subsystem, the wireless communications subsystem comprising:
an antenna subsystem;
a plurality of connectors for receiving respective ones of a plurality of wireless communications modules;
a unit for manipulating RF signals coupled to the antenna subsystem and to the plurality of connectors; and
a controller coupled to the unit for manipulating RF signals and to a host processor of the mobile electronic device for controlling the unit for manipulating RF signals to connect a selected one of the connectors to the antenna subsystem.

2. The wireless communications subsystem of claim 1, wherein the antenna subsystem comprises a plurality of antennas.

3. The wireless communications subsystem of claim 1, wherein the unit for manipulating RF signals is configured to connect a selected one of the wireless communications modules to one or more selected antennas.

4. The wireless communications subsystem of claim 1, wherein the unit for manipulating RF signals is configured to perform impedance matching to cause the antenna subsystem to present a known impedance to a wireless communications module.

5. The wireless communications subsystem of claim 1, wherein the unit for manipulating RF signals is configured to perform active noise cancellation to mitigate effects of noise from the mobile electronic device on signals received by the antenna subsystem.

6. The wireless communications subsystem of claim 1, wherein the antenna subsystem comprises a phased array antenna.

7. The wireless communications subsystem of claim 1, wherein the unit for manipulating RF signals is configured to perform gain control of RF signals from the wireless communications modules.

8. The wireless communications subsystem of claim 1, wherein the unit for manipulating RF signals is configured to perform phase control of RF signals from the wireless communications modules.

9. The wireless communications subsystem of claim 1, wherein the antenna subsystem comprises at least one frequency-adjustable antenna.

10. The wireless communications subsystem of claim 1, wherein the unit for manipulating RF signals is configured to perform frequency control of the frequency-adjustable antenna.

11. The wireless communications subsystem of claim 1, wherein the unit for manipulating RF signals is configured to control the antenna subsystem to perform beam steering of an antenna beam toward a signal source.

12. The wireless communications subsystem of claim 1, wherein the unit for manipulating RF signals is configured to control the antenna subsystem to perform null steering of an antenna null toward an interference source.

13. The wireless communications subsystem of claim 1, wherein the mobile electronic device comprises a display housing portion and a keyboard housing portion, the unit for manipulating RF signals being housed in the display housing portion.

14. The wireless communications subsystem of claim 1, wherein the connectors are housed in the keyboard housing portion.

15. A method of wireless communications in a mobile electronic device comprising an antenna subsystem and a plurality of wireless communications modules, comprising:
supplying RF signals from each of the wireless communications modules to a single unit for manipulating the RF signals; and
controlling the unit for manipulating RF signals to connect an RF signal of a selected one of the wireless communications modules to the antenna subsystem.

16. The method of claim 15, wherein the antenna subsystem comprises a plurality of antennas, comprising controlling the unit for manipulating RF signals to connect a selected one of the wireless communications modules to one or more selected antennas.

17. The method of claim 15, wherein the unit for manipulating RF signals comprises an impedance matching circuit, comprising controlling the unit for manipulating RF signals to cause the antenna subsystem to present a known impedance to a wireless communications module.

18. The method of claim 15, wherein the unit for manipulating RF signals comprises an active noise cancellation circuit, comprising controlling the unit for manipulating RF signal to perform active noise cancellation to mitigate effects of noise from the mobile electronic device on signals received by the antenna subsystem.

19. The method of claim 15, wherein the unit for manipulating RF signals comprises a gain control circuit, comprising controlling the unit for manipulating RF signals to perform gain control of RF signals from the wireless communications modules.

20. The method of claim 15, wherein the unit for manipulating RF signals comprises a phase control circuit, comprising controlling the unit for manipulating RF signals perform phase control of RF signals from the wireless communications modules.

21. The method of claim 15, wherein the antenna subsystem comprises at least one frequency-adjustable antenna, comprising controlling the unit for manipulating RF signals to perform frequency control of the frequency-adjustable antenna.

22. The method of claim 15, wherein the antenna subsystem comprises a phased array antenna, comprising controlling the unit for manipulating RF signals to perform beam steering of an antenna beam toward a signal source.

23. The method of claim 15, wherein the antenna subsystem comprises a phased array antenna, comprising controlling the unit for manipulating RF signals to perform null steering of an antenna null toward an interference source.

24. The method of claim 15, wherein the mobile electronic device comprises a display housing portion and a keyboard housing portion, the unit for manipulating RF signals being housed in the display housing portion and the wireless communications modules being housed in the keyboard housing portion, comprising conveying RF signals from the wireless communications modules to the unit for manipulating RF signals.
